(19) United States
(12) Patent Application Publication
(10) Pub. No.: US 2012/0042562 A1
(43) Pub. Date: Feb. 23, 2012

(54) CLIPPING TYPE MOUSE GLUE TRAP

(76) Inventor: WEI-AN LIAO, New Taipei City (TW)

(21) Appl. No.: 13/193,619

(22) Filed: Jul. 29, 2011

(30) Foreign Application Priority Data
Aug. 23, 2010 (TW) 099216215

(51) Int. Cl. A01M 23/00

(52) U.S. Cl. 43/58

(57) ABSTRACT

A clipping type mouse glue trap includes two openable/closable boards and at least one elastic member. The two boards have top surfaces coated with layers of glue. The elastic member has two ends respectively fixed to outer edge portions of the two boards. The two boards have bottom surfaces to which a plurality of fulcrum stands is mounted. The fulcrum stands and inner edge portion of each board define a closing section. When a mouse contacts the closing section of the board or the outer edge portion of the board and starts to struggle, the two boards use the arrangement of the fulcrum stands to close to each other. The elastic member makes the two boards closed toward each other in a quick and powerful manner to effectively stick the mouse to the glue layers of the two boards, preventing the mouse from freeing itself with the struggling.

### (a) TECHNICAL FIELD OF THE INVENTION

The present invention generally relates to a mouse trap, and more particularly to a clipping type mouse glue trap.

### (b) DESCRIPTION OF THE PRIOR ART

Mice often bite and even steal foodstuffs and damage furniture and electrical appliances. Mice also stinking and may transmit diseases, such as black plague. Further, some young children or even adult females are often scared by the appearance of mice. For all these reasons, government agencies continuously devoted themselves in terminating mice in order to alleviate the damages and threats that mice impose on the society and general household environments.

To address the problem of mice, various mouse traps or chemical agents have been developed and are available in the market, such as cage trap, spring-loaded bar trap, glue trap, and mouse poison. These devices or chemical agents are placed at sites where mice move around or pass to attract the mice passing by so as to catch the mice that accidentally touch the devices or to kill the mice that are attracted to bite bait containing the mouse poison.

However, it is noted that a cage trap shows only very limited performance and a spring-loaded bar trap may accidentally hurt people who touch the trap incautiously. The glue trap traps a mouse by adhesively keeping the mouse that steps on the trap, but forcible struggle often allows the mouse caught by the glue trap to free itself from the trap. The mouse poisons often bring up concerns of safety, for a young child may accidentally swallow the mouse bait that contains the poison, leading to undesired damage to his or her life and health.

Apparently, all the known ways of catching or killing mice have drawbacks and improvement is desired.

The present invention aims to provide a clipping type mouse glue trap that effectively overcomes the above discussed problems of the know devices.

### SUMMARY OF THE INVENTION

An objective of the present invention is to provide a clipping type mouse glue trap, wherein the clipping type mouse glue trap comprises two boards, which are allowed to close to each other when a mouse gets stuck to a glue layer of the mouse trap, so that the mouse is effectively stuck by the glue layer of the boards and is prevented from freeing itself through strong struggling.

To achieve the above objective, the present invention provides a clipping type mouse glue trap, which comprises two boards, at least one opening/closing member, at least one elastic member, and a plurality of fulcrum stands. The two boards each have a top surface and a bottom surface. The top surface of each board is coated with a glue layer. Each of the two boards has an inner edge portion and an outer edge portion. The two boards are connected to each other with the inner edge portions. The opening/closing member has two sides that respectively coupled to the inner edge portions of the two boards, whereby the two boards are expandable and/or collapsible with the opening/closing member. The elastic member has two ends respectively fixed to the outer edge portions of the two boas so that the two boards are selectively driven by the elastic member for quickly closing. The bottom surface of each of the boards comprises four fulcrum stands fixed thereto, among which two of the fulcrum stands are located adjacent to the outer edge portion of the board, while the remaining two fulcrum stands are set at a middle section of the board and closer to the inner edge portion, whereby the middle section fulcrum stands and the inner edge portion of the board define a closing section.

With the technical solution adopted by the present invention, since a mouse is caught by two boards closing from opposite sides, when a mouse contacts the closing section of the board or the outer edge portion of the board and starts to struggle, the two boards use leverage induced by the fulcrum stands arranged at the middle sections of the bottom surfaces of the boards to close to each other. The elastic member makes the boards closed toward each other in a quick and powerful manner. As such, the present invention improves the efficiency of catching mouse and also prevents the mouse from freeing itself from the glue trap with strong struggling.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a clipping type mouse glue trap according to a first embodiment of the present invention.

FIG. 2 is a perceptive view of the mouse trap of the present invention with elastic members being attached to two boards of the mouse trap.

FIG. 3 is a perspective view of the mouse trap of the present invention, showing bottom side of the boards.

FIG. 4 is a perspective view illustrating the mouse trap according to the first embodiment of the present invention catching a mouse.

FIG. 5 is a side elevational view illustrating collapse of the mouse trap according to the present invention.

FIG. 6 is a perspective view illustrating the mouse trap according to the first embodiment of the present invention clipping a mouse.

FIG. 7 is a perspective view illustrating a mouse trap according to a second embodiment of the present invention catching a mouse.

FIG. 8 is a perspective view illustrating a mouse trap according to a third embodiment of the present invention.

FIG. 9 is a perspective view illustrating a mouse trap according to a fourth embodiment of the present invention.

FIG. 10 is a perspective view illustrating a mouse trap according to a fifth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

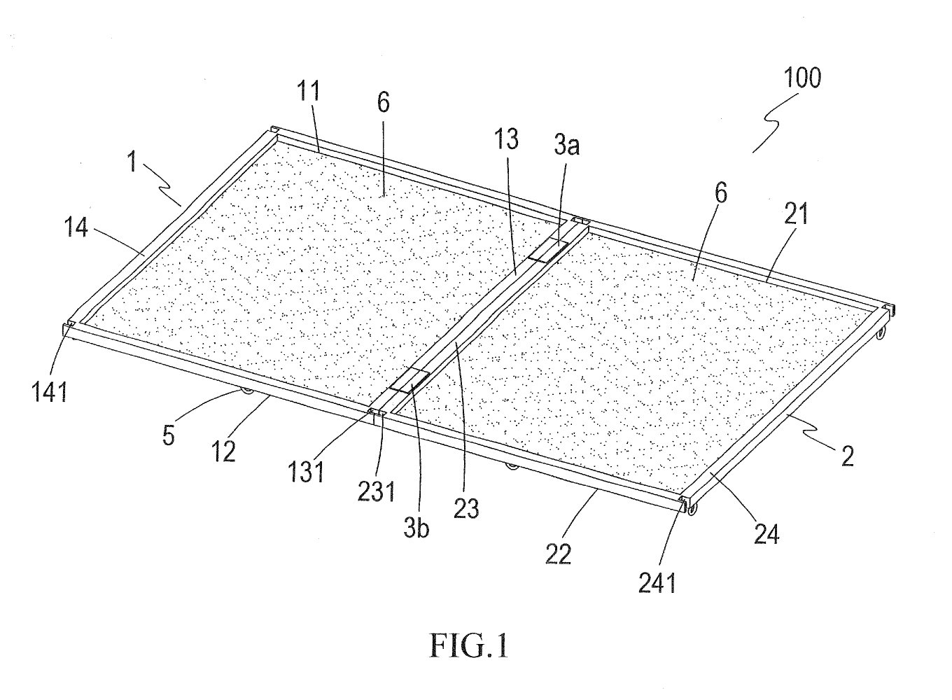

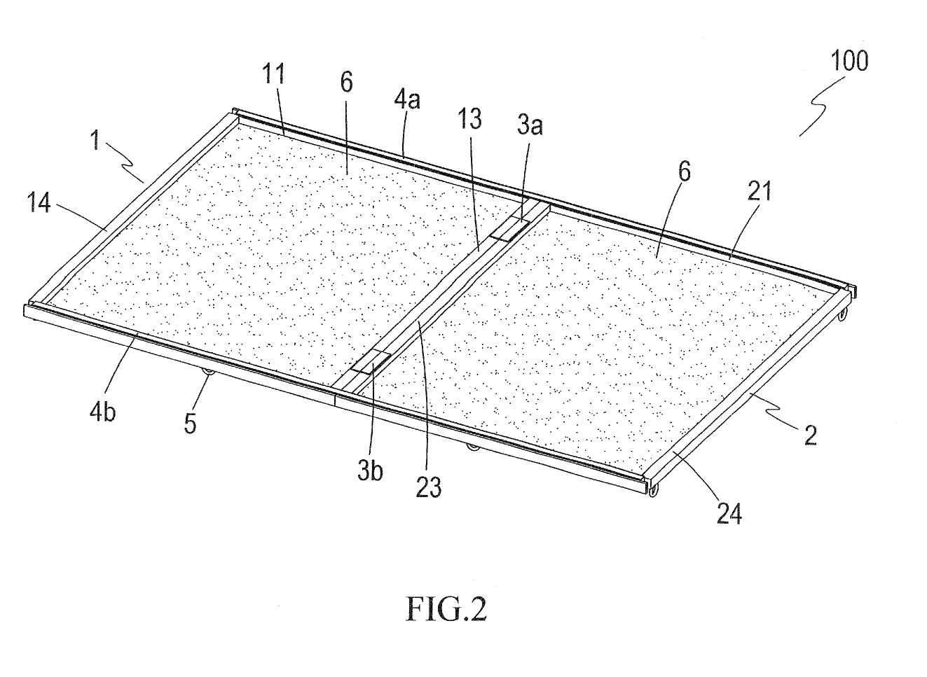

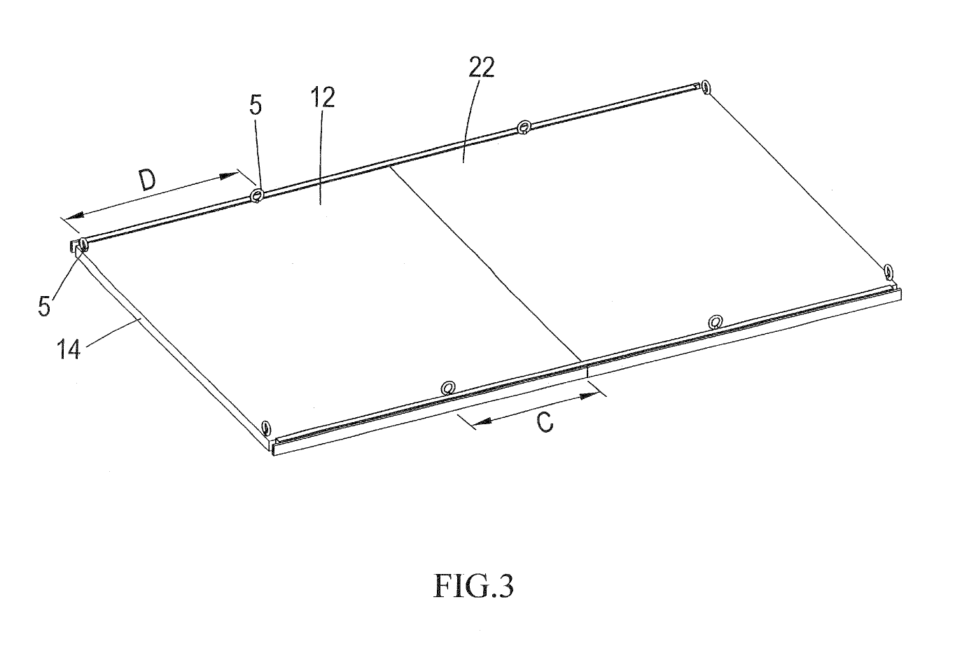

Referring to FIGS. 1-3, FIG. 1 is a perspective view showing a clipping type mouse glue trap according to a first embodiment of the present invention; FIG. 2 is also a perceptive view of the mouse trap of the present invention with elastic members being attached to two boards of the mouse trap; and FIG. 3 is a perspective view of the mouse trap of the present invention, showing bottom side of the boards. As shown in the drawings, the clipping type mouse glue trap according to the present invention, generally designated at 100, comprises a board 1 and a board 2, two opening/closing members 3a, 3b, two elastic members 4a, 4b, and a plurality of fulcrum stands 5.

The board 1 has a top surface 11 and a bottom surface 12, and the board 1 has an inner edge portion 13 and an outer edge portion 14. Similarly, the board 2 has a top surface 21 and a bottom surface 22, and the board 2 has an inner edge portion 23 and an outer edge portion 24. The top surface 11 of the board 1 is coated with a layer of glue 6, and the top surface 21 of the board 2 is similarly coated with a layer of glue 6. The inner edge portion 13 of the board 1 has opposite ends respectively forming a notch 131 and the outer edge portion 14 has opposite ends that similarly and respectively form a notch 141. The inner edge portion 23 of the board 2 has two ends respectively forming a notch 231, and the outer edge portion 24 of the board 2 has two ends respectively forming a notch 241. The inner edge portion 13 of the board 1 is coupled to the inner edge portion 23 of the board 2.

The two opening/closing members 3a, 3b each have two sides that are respectively coupled to the inner edge portion 13 of the board 1 and the inner edge portion 23 of the board 2, whereby the board 1 and the board 2 are expandable and/or collapsible with the opening/closing members 3a, 3b

Referring to FIG. 2, the elastic member 4a has two ends that are respectively attached to one of the notches 141 of the outer edge portion 14 of the board 1 and the corresponding one of the notches 241 of the outer edge portion 24 of the board 2, while the elastic members 4b has two ends that are respectively attached to the other one of the notches 141 of the outer edge portion 14 of the board 1 and the corresponding notch 241 of the outer edge portion 24 of the board 2, whereby the board 1 and the board 2 can realize automatic closing or collapse with the elastic members 4a, 4b. In the instant embodiment, the elastic members 4a, 4b comprise elastic bands, but they can be replaced by springs or other elastic members in different embodiments. Further, in the instant embodiment, two elastic members 4a, 4b are provided for being attached to the outer edge portion 14 of the board 1 and he outer edge portion 24 of the board 2, yet it is noted that the number of the elastic members 4a, 4b as mentioned herein is just an illustrative example and modifications of such an illustrative example can be made by for example using a single elastic members 4a or 4b that is attached to the outer edge portions 14, 24 of the board 1 and the board 2.

Referring to FIG. 3, the bottom surfaces 12, 22 of the board 1 and the board 2 are respectively provided with the plurality of fulcrum stands 5. Taking the board 1 as an example for explanation, the bottom surface 12 of the board 1 are provided with four fulcrum stands 5 securely fixed thereto, among which two fulcrum stands 5 are set at the outer edge portion 14 of the board 1 and are respectively adjacent to the notches 141 of the outer edge portion 14, while the other two fulcrum stands 5 are set at a middle section of the board 1 and are slightly closer to the inner edge portion 13, wherein the middle section fulcrum stands 5 and the fulcrum stands 5 of the outer edge portion 14 are spaced from each other by a predetermined distance D and the middle section fulcrum stands 5 and the board 1 the inner edge portion 13 define therebetween a closing section C. The board 2 comprises fulcrum stands 5 that are arranged in the same way as those of the board 1, so that no further detail will be provided herein.

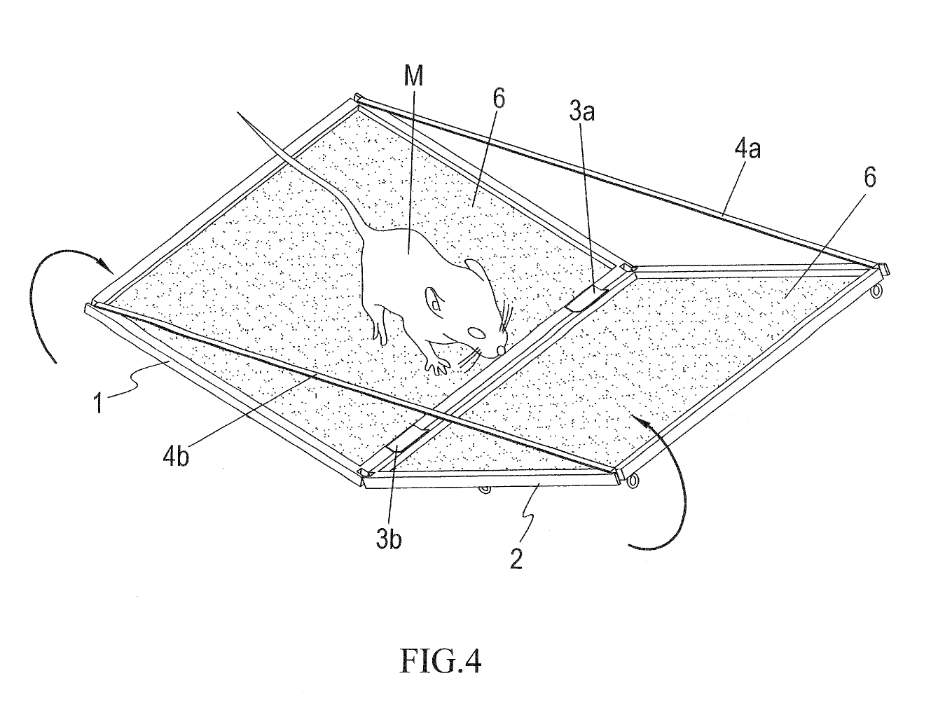

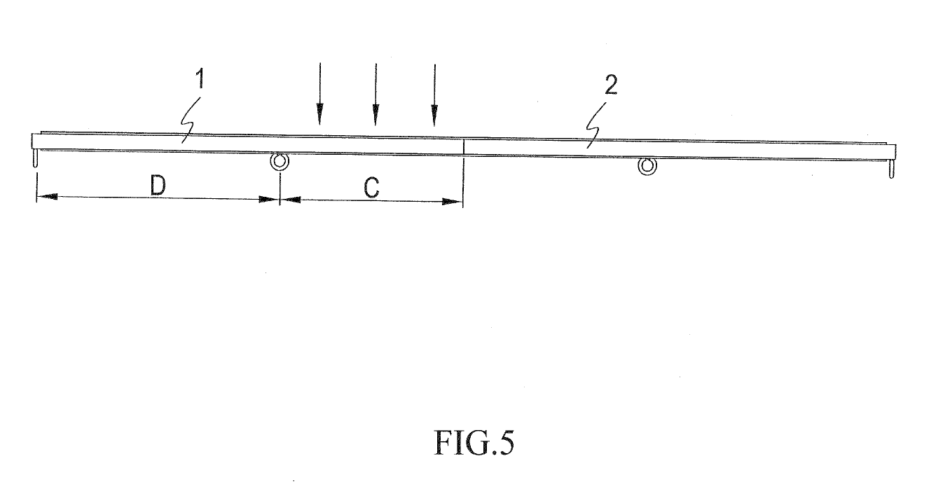

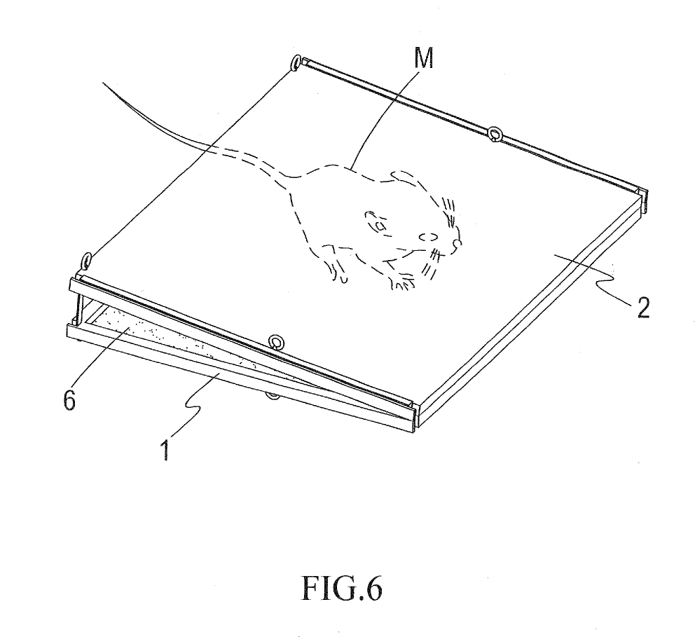

Referring to FIGS. 4-6, FIG. 4 is a perspective view illustrating the mouse trap according to the first embodiment of the present invention catching a mouse; FIG. 5 is a side elevational view illustrating collapse of the mouse trap according to the present invention; and FIG. 6 is a perspective view illustrating the mouse trap according to the first embodiment of the present invention clipping a mouse. As shown in the drawings, when the mouse trap according to the present invention is used to catch a mouse M, the mouse trap of the present invention is set up in such a way that the board 1 and the board 2 are expanded and properly deployed to wait for the visit of a mouse M.

When a mouse M steps on the board 1 of the mouse trap, the mouse M gets stuck to the glue layer 6 of the board 1. The mouse M, so stuck, often struggles for freedom. According to the present invention, the struggling of the mouse M that is stuck by the glue layer 6 of the board 1 causes vibration and shaking within the closing section C. Leverage about the middle section fulcrum stands 5 of the board 1 occurs, making the outer edge portion 14 of the board 1 moving in a direction substantially toward the inner edge portion of the board 1. Due to the arrangement of the opening/closing members 3a, 3b and the elastic members 4a, 4b, the board 2 is simultaneously driven to quickly close, thereby clipping the mouse M between the board 1 and the board 2, as shown in FIG. 6.

The locations where the middle section fulcrum stands 5 are fixed to the board 1 or the board 2 are illustrative as an example for explanation of the present invention. A user may change the locations as desired. However, it is noted that when the middle section fulcrum stands 5 of the board 1 or the board 2 are set at locations that are close to the inner edge portion 13, 23 of the board 1 or the board 2, then the sensitivity of the mouse trap that closes or collapses the board 1 and the board 2 due to a mouse M contacting and thus activating the closing section C is reduced. On the other hand, when the middle section fulcrum stands 5 are located close to the outer edge portion 14, 24, the sensitivity of the mouse trap for closing or collapsing the board 1 or the board 2 is raised.

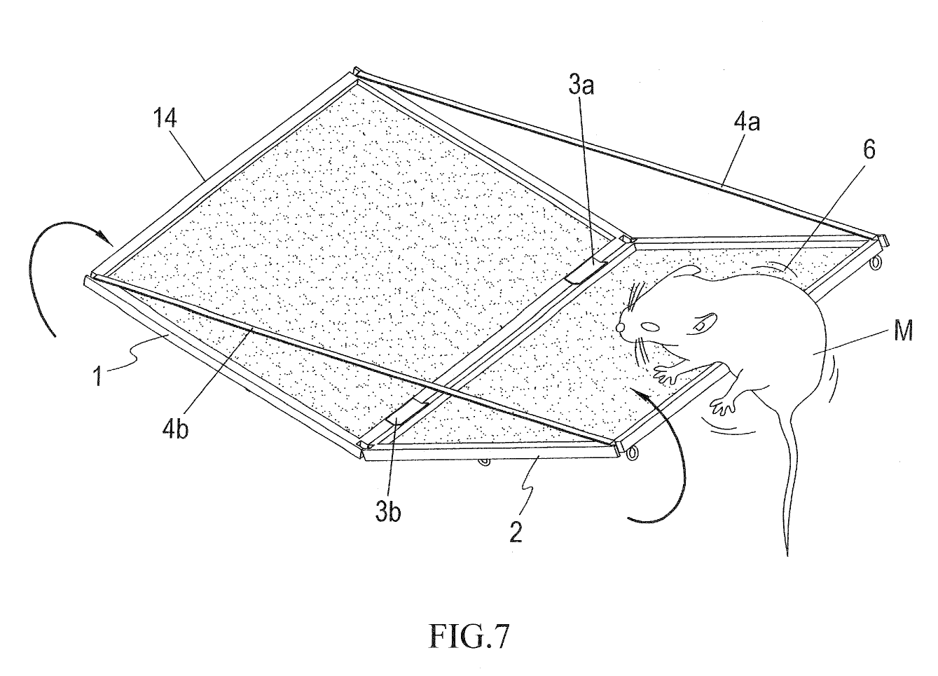

Referring to FIG. 7, which is a perspective view illustrating a mouse trap according to a second embodiment of the present invention catching a mouse, as shown in the drawing, the clipping type mouse glue trap 100 according to the instant embodiment comprises constituent components that are substantially similar to those of the first embodiment, and similar components are labeled with the same reference numeral for consistency and correspondence. A difference of the instant embodiment from the previous one is that the clipping type mouse glue trap 100 of the instant embodiment catches a mouse in such a way that when a front part of a mouse M is stuck by the glue layer 6 of the board 2, a rear part of the mouse M struggles, attempting to free itself from the board 2. Such struggling causes the board 2 to close or collapse, and at the same time, the elastic members 4a, 4b drive the board 1 to close simultaneously to thereby clip the mouse M between the board 1 and the board 2. The operation of the instant embodiment is similar to that of the first embodiment and no further detail is needed herein.

It can be seen from the first embodiment and the second embodiment described above that no matter where a mouse M enters the mouse trap of the present invention, when the mouse M gets stuck on the glue layer 6, the struggling of the mouse M will always trigger the mouse trap of the present invention to close or collapse thereby clipping the mouse M between the board 1 and the board 2. In this way, the area where a mouse M can be stuck and thus caught is increased and undesirably freeing the stuck mouse M due to the struggling of the mouse can be avoided, thereby improving the probability of successfully and efficiently catching a mouse.

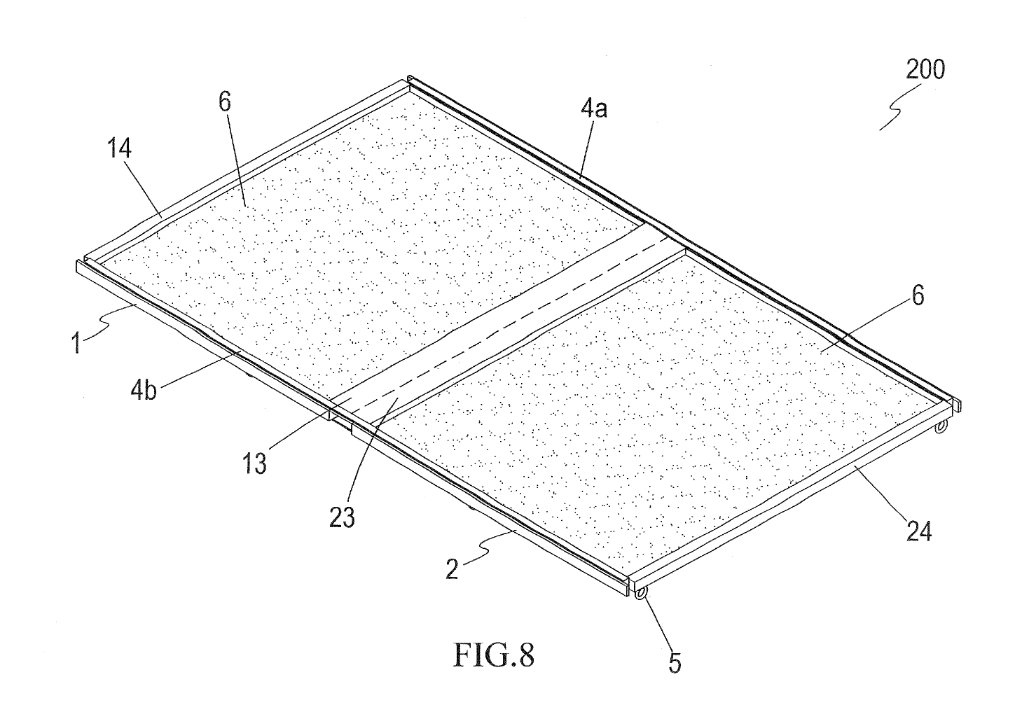

Referring to FIG. 8, which is a perspective view illustrating a mouse trap according to a third embodiment of the present invention, as shown in the drawing, the clipping type mouse glue trap 200 of the instant embodiment comprises constituent components that are substantially similar to those of the first embodiment, and similar components are labeled with the same reference numeral for consistency and correspondence. A difference of the instant embodiment from the previous one is that the clipping type mouse glue trap 200 of the instant embodiment comprises a board 1 having an inner edge portion 13 and a board 2 having an inner edge portion 23 of the board 2, in which the boards are coupled together by connecting the inner edge portions 13, 14 together so as to allow the board 1 and the board 2 to close or collapse and open or expand with the connected inner edge portions 13, 23. The operation of the instant embodiment is similar to that of the first embodiment and no further detail is needed herein.

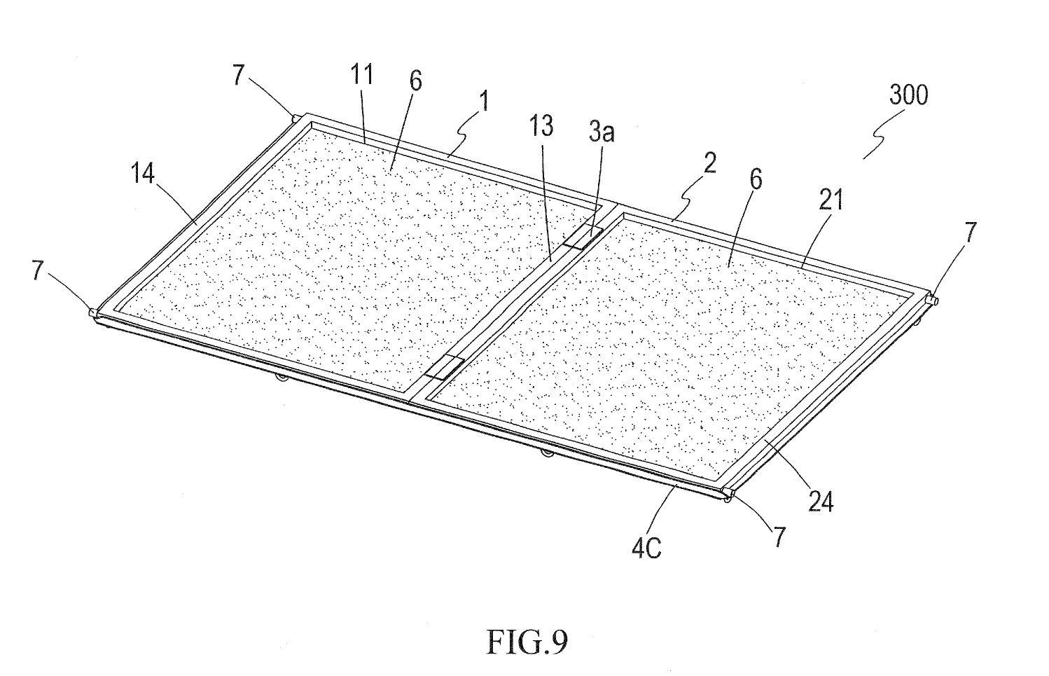

Referring to FIG. 9, which is a perspective view illustrating a mouse trap according to a fourth embodiment of the present invention, as shown in the drawing, the clipping type mouse glue trap 300 of the instant embodiment comprises constituent components that are substantially similar to those of the first embodiment, and similar components are labeled with the same reference numeral for consistency and correspondence. A difference of the instant embodiment from the previous one is that two fulcrum stands 7 are mounted to each of the outer edge portion 14 of the board 1 and the outer edge portion 24 of the board 2. These fulcrum stands 7 function to fix an elastic member 4c.

As shown in the drawing, in the instant embodiment, the elastic member 4c comprises a rubber band. The elastic member 4c has two ends that are respectively fixed to one of the fulcrum stands 7 of the outer edge portion 14 of the board 1 and one of the fulcrum stands 7 of the outer edge portion 24 of the board 2. With such an arrangement, the clipping type mouse glue trap 300 according to the instant embodiment can similarly use the elastic member 4c to quickly and powerfully drive the board 1 and the board 2 to close and collapse in catching a mouse M.

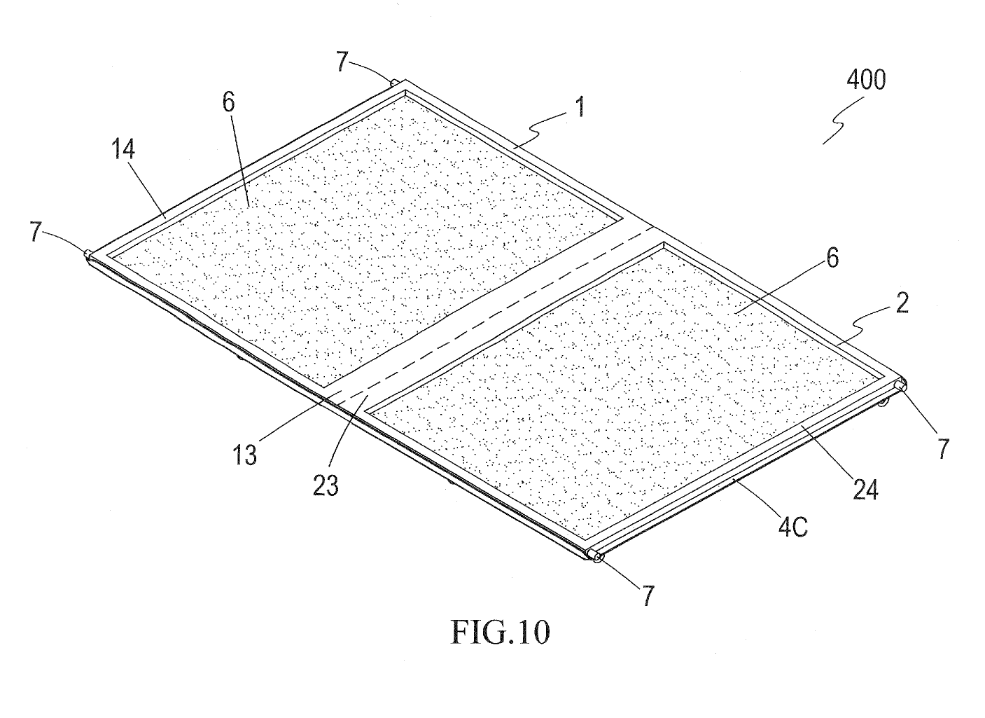

Referring to FIG. 10, which is a perspective view illustrating a mouse trap according to a fifth embodiment of the present invention, as shown in the drawing, the clipping type mouse glue trap 400 of the instant embodiment comprises constituent components that are substantially similar to those of the third embodiment, and similar components are labeled with the same reference numeral for consistency and correspondence. A difference of the instant embodiment from the previous one is that the clipping type mouse glue trap 400 of the instant embodiment comprises a board 1 having an outer edge portion 14 and a board 2 having an outer edge portion 24 to each of which two fulcrum stands 7 are attached. These fulcrum stands 7 function to fix an elastic member 4c.

As shown in the drawing, in the instant embodiment, the elastic member 4c comprises a rubber band. The elastic member 4c has two ends that are respectively fixed to one of the fulcrum stands 7 of the outer edge portion 14 of the board 1 and one of the fulcrum stands 7 of the outer edge portion 24 of the board 2. With such an arrangement, the clipping type mouse glue trap 400 according to the instant embodiment can similarly use the elastic member 4c to quickly and powerfully drive the board 1 and the board 2 to close and collapse in catching a mouse M.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A clipping type mouse glue trap, comprising:
two boards, each of which has a top surface and a bottom surface, the top surface of each board being coated with a glue layer, each of the two boards having an inner edge portion and an outer edge portion, the two boards being connected to each other with the inner edge portions;
at least one opening/closing member, which has two sides respectively coupled to the inner edge portions of the two boards;
at least one elastic member, which has two ends respectively fixed to the outer edge portions of the two boards; and
a plurality of fulcrum stands, which are respectively mounted to the bottom surfaces of the two boards.

2. The clipping type mouse glue trap according to claim 1, wherein each of the boards forms a notch in each of two ends of the inner edge portion and each of two ends of the outer edge portion, the two ends of the elastic member being respectively fixed to the notches of the outer edge portions of the two boards.

3. The clipping type mouse glue trap according to claim 1, wherein the outer edge portion of each of the two boards forms two fulcrum stands, the elastic member being fixed to the fulcrum stands of the outer edge portions of the two boards.

4. The clipping type mouse glue trap according to claim 2, wherein the bottom surface of each of the boards form two fulcrum stands respectively on left-side portion and right-side portion thereof, the two fulcrum stands being spaced from each other by a predetermined distance.

5. The clipping type mouse glue trap according to claim 4, wherein the elastic member comprises a rubber band or a spring.

6. The clipping type mouse glue trap according to claim 3, wherein the bottom surface of each of the boards form two fulcrum stands respectively on left-side portion and right-side portion thereof, the two fulcrum stands being spaced from each other by a predetermined distance.

7. The clipping type mouse glue trap according to claim 6, wherein the elastic member comprises a rubber band or a spring.

8. A clipping type mouse glue trap, comprising:
two collapsible boards, each of which has a top surface and a bottom surface, the top surface of each board being coated with a glue layer, each of the two boards having an inner edge portion and an outer edge portion, the inner edge portions of the two boards being connected to each other;
at least one elastic members, which has two ends respectively fixed to the outer edge portions of the boards; and
a plurality of fulcrum stands, which are respectively mounted to the bottom surfaces of the two boards.

9. The clipping type mouse glue trap according to claim 8, wherein each of the boards forms a notch in each of two ends of the inner edge portion and each of two ends of the outer edge portion, the two ends of the elastic member being respectively fixed to the notches of the outer edge portions of the two boards.

10. The clipping type mouse glue trap according to claim 8, wherein the outer edge portion of each of the two boards forms two fulcrum stands, the elastic member being fixed to the fulcrum stands of the outer edge portions of the two boards.

11. The clipping type mouse glue trap according to claim 9, wherein the bottom surface of each of the boards form two fulcrum stands respectively on left-side portion and right-side portion thereof, the two fulcrum stands being spaced from each other by a predetermined distance.

12. The clipping type mouse glue trap according to claim 11, wherein the elastic member comprises a rubber band or a spring.

13. The clipping type mouse glue trap according to claim 10, wherein the bottom surface of each of the boards form two fulcrum stands respectively on left-side portion and right-side portion thereof, the two fulcrum stands being spaced from each other by a predetermined distance.

14. The clipping type mouse glue trap according to claim 13, wherein the elastic member comprises a rubber band or a spring.
